(19) United States
(12) Patent Application Publication
(10) Pub. No.: US 2016/0100093 A1
(43) Pub. Date: Apr. 7, 2016

(54) LIVE VIDEO SYSTEM

(71) Applicant: Fire Cam, LLC, Belleville, IL (US)

(72) Inventors: Robert Schield, Belleville, IL (US); Stephen Stefanowicz, Gold Coast (AU); Adele Whish-Wilson, Prahran (AU); Andrew Rowsell, Prahran (AU)

(21) Appl. No.: 14/873,055

(22) Filed: Oct. 1, 2015

Related U.S. Application Data
(60) Provisional application No. 62/058,538, filed on Oct. 1, 2014.

(51) Int. Cl. H04N 5/232; H04N 1/21

(52) U.S. Cl. CPC H04N 5/23206; H04N 1/2158; H04N 1/212

(57) ABSTRACT

A live video system is provided. The system includes a camera, a mobile device, and a wireless communication link between the camera and the mobile device, wherein video and audio captured by the camera is sent to the mobile device. The mobile device may further include a live video software application, wherein the live video software application provides instruction to a processor of the mobile device to activate a mobile network connection with a server to send video and audio captured by the camera and received by the mobile device through the mobile network connection to the server for streaming. The camera further includes local memory and may record audio and video simultaneously with the sending the audio and video to the mobile device, wherein the recording is in high definition and remains in the custody of the emergency personnel in order to maintain proper custody for evidence purposes.

### CROSS REFERENCE TO RELATED APPLICATION[S]

This application claims priority to U.S. Provisional patent application entitled “Live Video System,” Ser. No. 62/058,538, filed Oct. 1, 2014, the disclosure of which is hereby incorporated entirely herein by reference.

### BACKGROUND OF THE INVENTION

1. Technical Field

This invention relates generally to live video system and more particularly to a live video system for use by emergency services personnel to stream live video.

2. State of the Art

Cameras to stream video are being used in many different situations. The use of cameras to stream video for emergency services personnel is lacking and further does not provide for high quality evidence video that remains in proper chain of custody. Web cams are utilized for streaming video and they lack the ability to stream in mobile applications.

Accordingly, there is a need for proper streaming with evidence backup video for use by emergency services personnel.

### SUMMARY OF EMBODIMENTS OF THE INVENTION

The present invention relates to a live video system that allows for live streaming of videos and further allows for local storage of high quality video for evidence purposes.

According to embodiments, a live video system comprises a camera, a mobile device, and a wireless communication link between the camera and the mobile device, wherein video and audio captured by the camera is sent to the mobile device. The mobile device may further include a live video software application, wherein the live video software application provides instruction to a processor of the mobile device to activate a mobile network connection with a server to send video and audio captured by the camera and received by the mobile device through the mobile network connection to the server for streaming. The streaming video may be accessible from other computing devices through the Internet or other types of connectivity. The camera further includes local memory and may record audio and video simultaneously with the sending the audio and video to the mobile device, wherein the recording is in high definition and remains in the custody of the emergency personnel in order to maintain proper custody for evidence purposes.

In embodiments, a live video system comprises a camera having a memory, a processor, and a live video software application stored in the memory of the mobile device, wherein the live video software application provides instruction to the processor of the camera to activate a mobile network connection with a server to send video and audio captured by the camera through the mobile network connection to the server for streaming. The streaming video may be accessible from other computing devices through the Internet or other types of connectivity. The camera further may record audio and video simultaneously with the sending the audio and video to the server, wherein the recording is in high definition and remains in the custody of the emergency personnel in order to maintain proper custody for evidence purposes.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a live video system in accordance with embodiments;

FIG. 2 is a diagrammatic view of a camera for use in a live video system in accordance with embodiments;

FIG. 3 is a diagrammatic view of mobile device for use in a live video system in accordance with embodiments;

FIG. 4 is a diagrammatic view of another live video system in accordance with embodiments; and

FIG. 5 is a diagrammatic view of a camera for use with the live video system of FIG. 4 in accordance with embodiments.

### DETAILED DESCRIPTION OF EMBODIMENTS OF THE INVENTION

As discussed above, embodiments of the present invention relate to a live video system that allows for live streaming of videos and further allows for local storage of high quality video for evidence purposes. The Live Video System is an improvement to a U.S. Patent Publication No. 2006/0095949 entitled, “Method and computer program for providing visual information to a viewer,” the disclosure of which is incorporated entirely herein by reference.

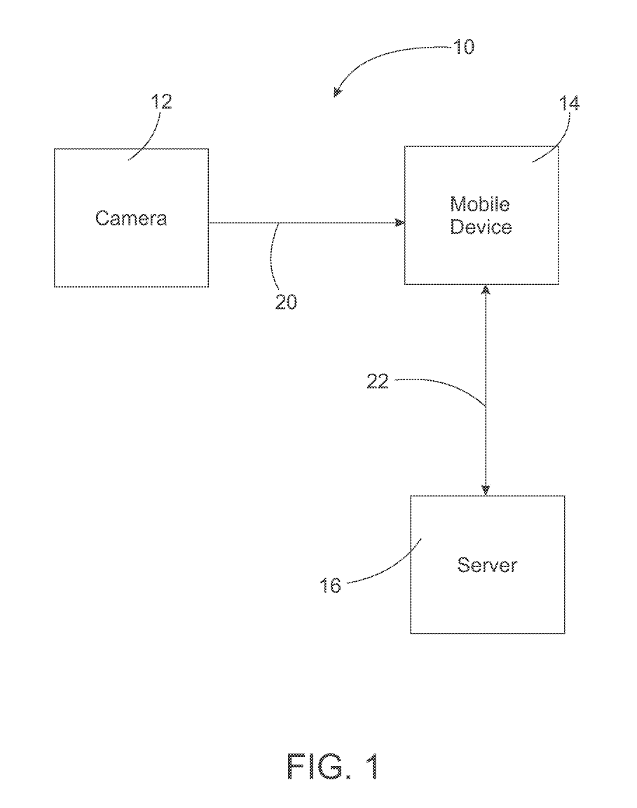

Referring to the drawings. FIGS. 1-3 depict a live video system 10 in according with an embodiment. The system 10 enables emergency services personnel to stream live video and audio from a camera 12 by tethering the camera 12 to a mobile device 14, through a wireless communication link 20. The wireless communication link 20 may be a Wi-Fi connection. In other embodiments, the wireless communication link 20 may any wireless network connection.

The system 10 also includes a server 16, wherein the mobile device 14 establishes a mobile network connection 22 with the server 14. The mobile network connection 22 may be a 3G, a 4G or other mobile network connection. The camera 12 may then send audio and/or video through the wireless communication link 20 to the mobile device 14. The mobile device 14 may then transmit the audio and/or video to the server 16 through the mobile network connection 22. The audio and/or video may then be streamed to viewers in real-time via the server 16.

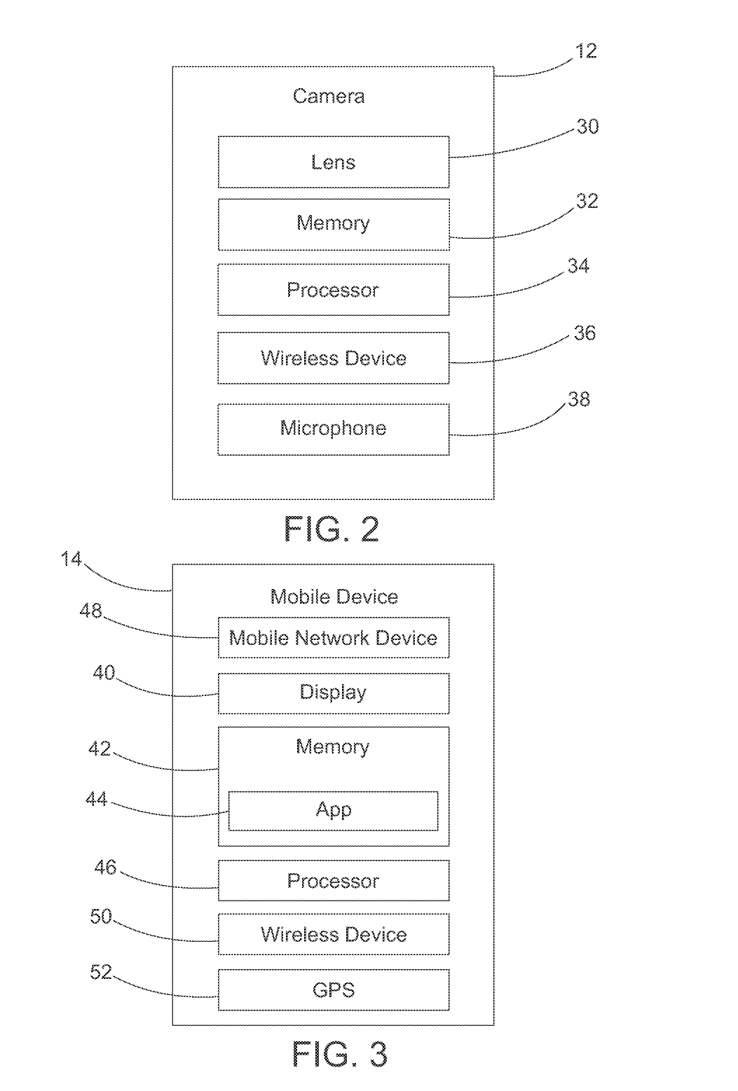

The camera 12, as shown in FIG. 2 is a Wi-Fi enabled camera 12, wherein the camera 10 includes a lens 30, a memory 32, a processor 34, a Wi-Fi device 36, and a microphone 38. The memory 32 may store software application(s) for operating the camera 12, wherein the processor 34 processes instructions from the software application(s) in order for the camera 12 to capture electronic audio and video through the microphone 38 and lens 30 respectively. The camera 12 may also have the capability to take high resolution snap shots during the capturing of the audio and video. These high resolution snap shots may be transmitted in other forms other than streaming.

The mobile device 14, as shown in FIG. 3, may include a display 40, a memory 42 having a live video application 44 stored therein, a processor 46, a mobile network device 48, and a Wi-Fi device 50. The display 40 allows a user to see a graphical user interface in order to interact with and operate the live video application 44. In embodiments, the mobile device 14 may be a smartphone, a tablet, a phablet and the like. The display 40 may be a touchscreen display, wherein the display 40 operates as an input device also.

A user may activate the live video application 44 in response to a user performing an activation input step through the touch screen, such as touching an icon to start the live video application 44. The processor 46 then executes the instructions provided by the live video application 44 stored in the memory 42. This helps to establish a wireless connection link 20 between the camera 12 and the mobile device 14. For example, as shown and not as a limitation, the Wi-Fi device 36 of the camera 12 may communication with the Wi-Fi device 50 of the mobile device 14, wherein audio and video is transmitted through the Wi-Fi connection between the camera 12 and the mobile device 14.

Operation of the live video application 44 further establishes the mobile network connection 22 with the server 16. This mobile network connection 22 provides a means for mobile device 14 to transmit audio and video captured by camera 12 and received by the mobile device 14 to the server 16. The live video application 44 may accomplish this in real-time, wherein the server 16 is receiving audio and video at approximately real-time as the audio and video is being captured.

The live video system 10 is optimized for streaming over the mobile network connection 22 and delivers the most reliable, low latency, high quality streaming possible, while keeping the cost of data low. Further, the live video system 10 can send the GPS location of mobile device 12 in real-time so viewers can know the position of the broadcasting mobile device from the web or the live video application 44 operating on the mobile device.

The mobile device 14 may also include a GPS device 52. The GPS device 52 operates to determine the GPS location of the mobile device 14 and the mobile device 14 may then communicate the GPS location to the server 16 through the mobile network connection 22.

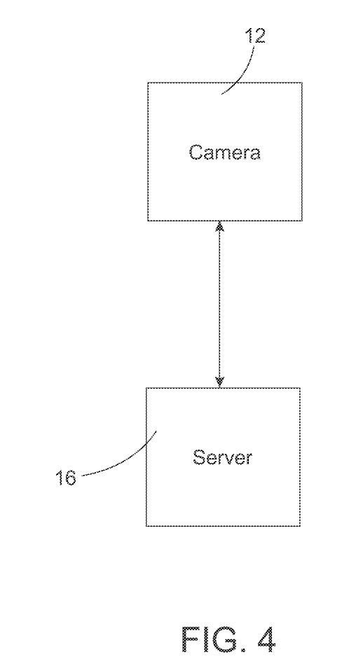

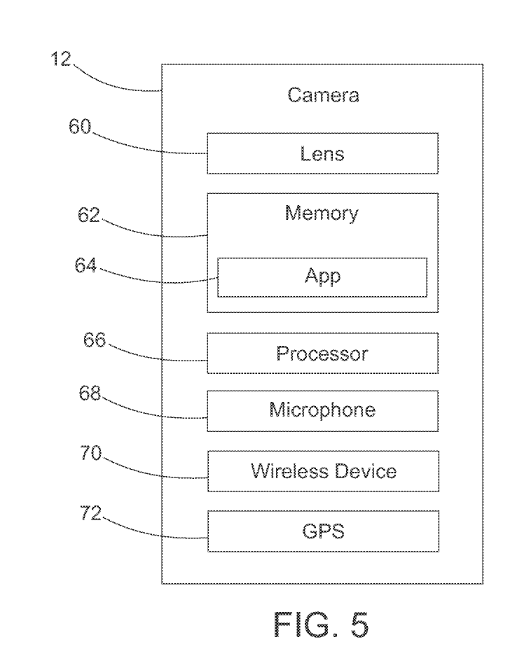

Referring again to the drawings, FIGS. 4-5 depict a live video system 10 in according with an embodiment. The system 10 enables emergency services personnel to stream live video and audio from a camera 12 to a server 16, through a mobile network connection 22 with the server 14. The mobile network connection 22 may be a 3G, a 4G or other mobile network connection. The audio and/or video may then be streamed to viewers in real-time via the server 16.

The camera 12, as shown in FIG. 5, includes a lens 60, a memory 62, a live video application 64 a processor 66, a mobile network device 68, and a microphone 70. The memory 62 may store software application(s) for operating the camera 12, wherein the processor 66 processes instructions from the software application(s) in order for the camera 12 to capture electronic audio and video through the microphone 70 and lens 60 respectively. The camera 12 may also have the capability to take high resolution snap shots during the capturing of the audio and video. These high resolution snap shots may be transmitted in other forms other than streaming.

A user may activate the live video application 64 in response to a user performing an activation input step through the camera 12, such as pressing a button to start the live video application 64. The processor 66 then executes the instructions provided by the live video application 64 stored in the memory 62. This establishes the mobile network connection 22 with the server 16. This mobile network connection 22 provides a means for camera 12 to transmit audio and video captured by camera 12 and to the server 16. The live video application 64 may accomplish this in real-time, wherein the server 16 is receiving audio and video at approximately real-time as the audio and video is being captured.

The live video system 10 is optimized for streaming over the mobile network connection 22 and delivers the most reliable, low latency, high quality streaming possible, while keeping the cost of data low. Further, the live video system 10 can send the GPS location of mobile device 12 in real-time so viewers can know the position of the broadcasting mobile device from the web or the live video application 44 operating on the mobile device.

The camera 12 may also include a GPS device 72. The GPS device 72 operates to determine the GPS location of the camera 12 and the camera 12 may then communicate the GPS location to the server 16 through the mobile network connection 22.

In general, an emergency department's cameras 12 connect to the department's private organization account on the server 16. This allows dispatch, management or Incident Command to securely access live video streams and location of personnel being captured by the cameras 12 and transmitted through mobile devices 14. Multiple viewers can connect in real-time from any computing device, such as, but not limited to a computer, tablet, laptop, smartphones, iPhone/iPad, Android devices and the like. The live streams may be recorded by the server 16 for post event analysis and training.

The Wi-Fi cameras 12 used with the live video system 10 record HD 1080p video and audio onto the camera's internal memory or removable memory, such as an SD card, to preserve a high quality version of the video needed for evidence.

Features of the live video system include:
Account based user authentication;
Auto-Buffer-Management keeps video streaming as close to real-time as possible;
Hi-res snapshots can be taken within the live video stream;
Save snapshots to your device and share via email, MMS, etc; and
Track GPS location of the Broadcaster.

Broadcasting features include the following:
Use the phones native camera or a Wi-Fi enabled camera;
Auto-detect mobile or Wi-Fi network connection;
Digital Zoom;
Auto-focus, auto white-balance;
Take high quality snapshots within the live stream;
Live session snapshot gallery shared by all viewers in real-time;
Save snapshots to your device and share via email, MMS, etc;
Send GPS location with live stream;
Toggle audio on/off during the stream;
Record the live session at the server;
Offline Recording and Upload;
Add metadata (name, description, keywords) to recordings; and
Upload manager lets you select files to store in the cloud.

Wi-Fi Cameras 12 for use with Live Video System 10 streaming may record 1080p at 60 fps and selectable to 720p at 120 fps. The camera may record up to 64 GB. The camera 12 may have a 150 degree wide angle lens 30 that ensures the user captures everything in view. Further, the camera 12 is NFPA compliant and constructed of anodized heat resistant aluminum. The camera 12 can withstand and operate in interior fire temperatures up to 900° F. for short periods of time. The camera 12 may be water resistant. The camera 12 may also be used with fire helmet mounts, as well as mountable to any assault rifle or Picatinny rail.

Other embodiments of the Wi-Fi camera 12 may record 1080p at 60 fps or 720p at 120 fps. It may also record up to 64 GB to secure internal storage. The camera 12 may have a 150 degree wide angle lens 30 that ensures the user captures everything in view. The camera 12 easily attaches to any vest, coat or shirt. The camera 12 may be water resistant and further may include detachable rechargeable batteries with long battery life. The camera may further include high powered LED lights for optimal lighting in the dark. Other embodiments include IR lights for night vision. The camera 12 may also have built in Wi-Fi for live video and audio streaming between from the mobile device 14 to the server 16.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A live video system comprising:
a camera having a lens and a microphone;
a mobile device having a memory and a processor; and
a wireless communication link between the camera and the mobile device, wherein video and audio captured by lens and the microphone of the camera is sent to the mobile device, and wherein:
the mobile device comprises a live video software application stored in the memory of the mobile device, wherein the live video software application provides instruction to the processor of the mobile device to activate a mobile network connection with a server to send video and audio captured by the camera and received by the mobile device through the mobile network connection to the server for streaming.

2. The system of claim 1, wherein video and audio may be accessible from the server by other computing devices.

3. The system of claim 1, wherein the camera further comprises a memory, wherein the camera records audio and video and stores it in the memory simultaneously with sending the audio and video to the mobile device.

4. The system of claim 3, wherein the recorded audio and video is in high definition and remains in the camera in the custody of the emergency personnel in order to maintain proper custody for evidence purposes.

5. The system of claim 3, wherein the memory is internal to the camera.

6. The system of claim 3, wherein the memory is a removable memory.

7. The system of claim 1, wherein the wireless communication link is a Wi-Fi connection.

8. The system of claim 1, wherein the mobile device is a smartphone.

9. The system of claim 1, wherein the mobile device includes a GPS device.

10. The system of claim 9, wherein the GPS device determines a GPS location of the mobile device and sends the GPS location to the server through the mobile network connection.

11. The system of claim 1, wherein the camera is operable in interior fire temperatures up to 900° F.

12. A live video system comprising:
a camera having a lens, a microphone, a memory and a processor, wherein the lens and the microphone capture video and audio; and
a server, the camera comprises a live video software application stored in the memory of the camera, wherein the live video software application provides instruction to the processor of the camera to activate a mobile network connection with the server to send video and audio captured by the camera through the mobile network connection to the server for streaming.

13. The system of claim 12, wherein video and audio may be accessible from the server by other computing devices.

14. The system of claim 12, wherein the camera records audio and video and stores it in the memory simultaneously with sending the audio and video to the server.

15. The system of claim 14, wherein the recorded audio and video is in high definition and remains in the camera in the custody of the emergency personnel in order to maintain proper custody for evidence purposes.

16. The system of claim 14, wherein the memory is internal to the camera.

17. The system of claim 14, wherein the memory is a removable memory.

18. The system of claim 12, wherein the camera includes a GPS device.

19. The system of claim 18, wherein the GPS device determines a GPS location of the camera and sends the GPS location to the server through the mobile network connection.

20. The system of claim 12, wherein the camera is operable in interior fire temperatures up to 900° F.
